(19) United States
(12) Patent Application Publication
(10) Pub. No.: US 2026/0082325 A1
(43) Pub. Date: Mar. 19, 2026

(54) WAKEUP SIGNAL SYNCHRONIZATION

(71) Applicant: Telefonaktiebolaget LM Ericsson (publ), Stockholm (SE)

(72) Inventors: Kittipong KITTICHOKECHAI, Järfälla (SE); Yanpeng YANG, Järfälla (SE); Mohammad MOZAFFARI, Fremont, CA (US); Ajit NIMBALKER, Dublin, CA (US); Ravikiran NORY, San Jose, CA (US); Mattias ANDERSSON, Sundbyberg (SE)

(21) Appl. No.: 19/110,479

(22) PCT Filed: Sep. 19, 2023
(86) PCT No.: PCT/SE2023/050915

§ 371 Date: Mar. 11, 2025

Related U.S. Application Data
(60) Provisional application No. 63/408,333, filed on Sep. 20, 2022.

(51) Int. Cl. H04W 52/02

(52) U.S. Cl. CPC H04W 52/0229

(57) ABSTRACT

A method, system and apparatus are disclosed. A network node is configured to communicate with a wireless device (WD). According to one aspect, a method in a WD includes receiving a wakeup signal (WUS) synchronization sequence from the network node. The method includes synchronizing a wakeup receiver (WUR) of the WD according to the WUS synchronization sequence. The method also includes receiving by the WUR a WUS sequence from the network node.

### TECHNICAL FIELD

The present disclosure relates to wireless communications, and in particular, to wake-up signal synchronization.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

In addition to these standards, the Institute of Electrical and Electronic Engineers (IEEE) has developed and continues to develop standards for other types of wireless communication networks, including Wireless Local Area Networks (WLANs), including Wireless Fidelity (Wi-Fi) networks and Bluetooth networks. WLANS include wireless communication between access points (APs) and non-access point stations (STAs). Such IEEE standards include IEEE 802.11a/b/g/n/ac/ax and IEEE 802.15. A wake-up receiver (WUR), also referred to as a ‘wake-up radio,’ is a low power receiver in a wireless device which, when detecting a wake-up signal (WUS), wakes up the less power-efficient main receiver (baseband/RF) of the wireless device to detect an incoming message. The incoming message may be a paging signal (e.g., physical downlink control channel (PDCCH)) in paging occasions (PO). The paging schedules the paging message on physical downlink shared channel (PDSCH)). The WUS may lower energy consumption and lengthen device battery life, or at a fixed energy consumption, the downlink latency may be reduced (shorter discontinuous reception (DRX)/duty-cycles and more frequent checks for incoming transmissions).

FIG. 1 shows a location of a WUS and the paging occasion to which it is associated.

In general, there are two approaches for detecting a WUS:
Using the main receiver (e.g., first receiver):
   No need for additional dedicated hardware/receiver for monitoring the WUS;
   Coverage of the main receiver is not typically impacted;
   Limited power saving gain as the main receiver monitors the WUS;
Having a dedicated receiver (WUR):
   Extremely low power, simple and low-cost receiver architecture, relaxed requirements, noisier (i.e., less accurate) clock or oscillator;
   Significant power saving gain may be achieved by maximizing the time in which the main receiver may be in the sleep mode;
   Enablers for zero energy/battery-less devices, and energy harvesting operations; and/or
   There are coverage considerations given the tradeoff between WUR power consumption and sensitivity.

### WUS for NB-IoT and LTE-M

### 3GPP Technical Release 15 (3GPP Rel.-15)

In 3GPP Technical Release 15 (3GPP Rel-15), the WUS was specified for narrow band internet of things (NB-IOT) and long term evolution for machines (LTE-M). A motivation was wireless device energy consumption reduction. With the coverage enhancement, the PDCCH may be repeated many times. The WUS is relatively short and therefore requires less time for the wireless device to receive the WUS. A wireless device may check for a WUS at a certain time before its PO. If a WUS is detected, the wireless device may continue to check for the PDCCH in the PO. If not, which is most of the time, the wireless device may go back to a sleep state to conserve energy. Due to coverage enhancements, the WUS may be of variable length depending on the wireless device's coverage. FIG. 2 illustrates a WUS for NB-IOT and LTE-M.

A ‘Wake-up signal’ (WUS) is based on the transmission of a short signal that indicates to the wireless device that it should continue to decode the downlink (DL) control channel, e.g., full NPDCCH for NB-IOT. If such a signal is absent (discontinuous transmission (DTX), i.e., the wireless device does not detect it) then the wireless device may go back to sleep without decoding the DL control channel. The decoding time for a WUS is considerably shorter than that of the full narrowband physical downlink control channel (NPDCCH) since it usually only needs to contain one bit of information, whereas the NPDCCH may contain up to 35 bits of information. This, in turn, reduces wireless device power consumption and leads to longer wireless device battery life. The WUS is typically transmitted only when there is a paging for the wireless device. But if there is no paging for the wireless device, then the WUS is not transmitted (i.e., implying a discontinuous transmission (DTX)). In that case, the wireless device would go back to deep sleep, e.g., upon detecting DTX instead of the WUS. This is illustrated in FIG. 1, where blocks outside the broken-lined rectangle indicate possible WUS and PO positions, and blocks within the broken-lined rectangle indicate actual WUS and PO positions.

The 3GPP Rel-15 specification of a WUS is spread out over several parts of the long term evolution (LTE) 36-series standard, e.g., 3GPP Technical Specification (TS) 36.211 v15.14.0, 36.213 v15.15.0, 36.304 v15.8.0 and 36.331 v15.18.0.

### WUS Wireless Device Grouping Objective in 3GPP Rel-16

According to the 3GPP Rel-16 work item description (WID), the WUS is to be further developed to also include wireless device grouping, such that the number of wireless devices that are triggered by a WUS is further narrowed down to a smaller subset of the wireless devices that are associated with a specific PO.

This may reduce the false paging rate, i.e., avoid a given wireless device being unnecessarily woken up by a WUS transmission intended for another wireless device. This feature is referred to in 3GPP Rel-16 as group WUS (GWUS). However, this is not directly related to a WUR.

### 3GPP REL-17 NR PEI

In 3GPP Rel-17, a WUS for new radio (NR) is considered, then-called the “Paging Early Indication” (PEI). However, since at the time no coverage enhancement was specified for NR, the only gain for 3GPP Rel-17 PEI was for scenarios where the small fraction of wireless devices are in bad coverage and with large synchronization error due to the use of longer DRX cycles. The gain for such wireless devices were that, with the use of PEI, they would typically only have to acquire one synchronization signal block (SSB) before decoding PEI. This is instead of up to three SSBs if PEI is not used (a value often defined by wireless device vendors). So, for most wireless devices, 3GPP Rel-17 PEI would result in gains or increased performance.

The 3GPP Rel-17 PEI will also support wireless devices grouping for false paging reduction, similar to the 3GPP Rel-16 GWUS above> This is expected to provide some gains at higher paging loads.

In 3GPP RAN #93e it was considered that PEI will be PDCCH-based, as discussed below, making it much less relevant to the WUR (i.e., the main baseband receiver is required for decoding PEI).

### 3Gpp Rel-18 Nr Wur

3GPP Rel-18 concerns WUR for NR and improving energy efficiency compared to solutions specified in earlier releases. As explained above, generally the specification support needed to be able to use a WUR in the wireless device is the specification of a WUS and a long enough time gap between the WUS and the PDCCH in the PO (to allow the wireless device to start up the main receiver). Therefore, one difference from the 3GPP Rel-17 PEI is that the WUS in 3GPP Rel-18 should not be PDCCH-based and should allow for a simpler (low complexity), low power receiver, i.e., WUR with simple modulation and detection techniques (e.g., using on-off keying (OOK) modulation and non-coherent detection).

In 3GPP Rel-18, a study item on “low-power wake-up signal and receiver for NR” was approved. The relevant justification and objective sections of 3GPP RP-213645 are discussed below:

### Justification

5G systems are designed and developed targeting for both mobile telephony and vertical use cases. Besides latency, reliability, and availability, wireless device energy efficiency is also critical to 5G. Currently, 5G devices may have to be recharged per week or day, depending on individual's usage time. In general, 5G devices consume tens of milliwatts in radio resource control (RRC) idle/inactive state and hundreds of milliwatts in RRC connected state. Designs to prolong battery life is a necessity for improving energy efficiency as well as for better user experience.

Energy efficiency is even more critical for wireless devices without a continuous energy source, e.g., wireless devices using small rechargeable and single coin cell batteries. Among vertical use cases, sensors and actuators are deployed extensively for monitoring, measuring, charging, etc. Generally, their batteries are not rechargeable and expected to last at least few years as described in 3GPP Technical Report (TR) 38.875. v17.0.0. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle. To meet the battery life requirements above, eDRX cycle with a large value is expected to be used, resulting in high latency, which is not suitable for such services with requirements of both long battery life and low latency. For example, in fire detection and extinguishment use case, fire shutters are closed and fire sprinklers are turned on by the actuators within 1 to 2 seconds from the time the fire is detected by sensors. In this case, a long eDRX cycle cannot meet the delay requirements. eDRX is apparently not suitable for latency-critical use cases. Thus, the intention is to study ultra-low power mechanism that may support low latency in 3GPP Rel-18, e.g., lower than eDRX latency.

Currently, wireless devices may need to periodically woken once per DRX cycle, which dominates the power consumption in periods with no signaling or data traffic. If wireless devices are able to wake up only when they are triggered by, e.g., paging, power consumption could be dramatically reduced. This may be achieved by using a wake-up signal to trigger the main radio and a separate receiver which has the ability to monitor the wake-up signal with ultra-low power consumption. The main radio works for data transmission and reception, which may be turned off or set to a sleep mode (such as micro/light sleep in a connected mode and ultra-deep sleep in an idle mode) unless it is turned on.

The power consumption for monitoring the wake-up signal depends on the wake-up signal design and the hardware module of the wake-up receiver used for signal detecting and processing.

The study targets low-power WUS/WUR for power-sensitive, small form-factor devices including IoT use cases (such as industrial sensors and controllers) and wearables. Other use cases are not precluded, e.g., smart glasses and smart phones.

### Objective of Study Item (SI)

As opposed to the work on wireless device power savings in previous 3GPP releases, this study may not require existing signals to be used as a WUS. All WUS solutions identified may be able to operate in a cell supporting legacy wireless devices.

Solutions may target substantial gains compared to the existing 3GPP Rel-15/16/17 wireless device power saving mechanisms. Other aspects such as detection performance, coverage, wireless device complexity, should be covered by the evaluation.

The study item includes the following objectives:
Identify evaluation methodology (including the use cases) & key performance indicators (KPIs) [RAN1]:
   Primarily target low-power WUS/WUR for power-sensitive, small form-factor devices including IoT use cases (such as industrial sensors, controllers) and wearables:
      Other Use Cases Are Not Precluded;
Study and evaluate low-power wake-up receiver architectures [RANI, RAN4];
Study and evaluate wake-up signal designs to support wake-up receivers [RAN1, RAN4];
Study and evaluate L1 procedures and higher layer protocol changes needed to support the wake-up signals [RAN2, RAN1]; and
Study potential wireless device power saving gains compared to the existing 3GPP Rel-15/16/17 wireless device power saving mechanisms and their coverage availability, as well as latency impact. System impact, such as network power consumption, coexistence with non-low-power-WUR wireless devices, network coverage/capacity/resource overhead should be included in the study [RAN1]
   Note: The need for RAN2 evaluation will be triggered by RAN1 when necessary.

One benefit of the WUR is the reduction of the energy consumption of the receiver, such that, unless there is any paging and data for the wireless device, it may remain in a power-saving state. This will extend the battery life of the device, or alternatively enable shorter downlink latency (shorter DRX) at a fixed battery life. For short-range communication, the WUR power may be low enough (˜10 uW) that this may even, in combination with energy harvesting, enable the WUR to be continuously on (i.e., DRX or duty-cycling is not used) without the need for a battery. This may be considered as an enabler of battery-less devices towards 6G.

### IEEE WUR

In standards propagated by the Institute of Electrical and Electronics Engineers, IEEE, the support for WUR has been specified to a greater extent than in 3GPP. That is, the focus was on low-power WUR from the start, and the design uses the WUR not only for receiving the WUS but also other control signals and signaling, such as synchronization and mobility information. This allows the stations (corresponding to wireless devices in 3GPP) to only use the WUR when there is no user-plane data transmission ongoing.

Similar to the 3GPP approach, the use of the WUR is enabled in stations and not in access points (APs), which is for downlink communication. The AP advertises that it has WUR operational capability, along with WUR configuration parameters (among other information) in which band/channel WUR is operational, which may be different from the band/channel used for data transmission using the main receiver, e.g., a WUR in the 2.4 GHz band but data communication is in the 5 GHz band. Also note that the WUR operating channel is advertised in the beacon, and that the WUR discovery operating channel may be different from the WUR operating channel. Stations may then request to be configured with a WUR mode of operation. This request has to be granted by the AP, and in case it is granted, the station is further configured/setup for WUR mode of operation (the configuration is only valid for the connection to the associated AP, and further the configuration must be torn down/de-configured if the WUR is not used anymore). Both continuous WUR (receiver open all the time) and duty-cycled WUR (receiver only open during preconfigured time slots) mode of operations are supported. For the latter, the length of the duty-cycles and on-time during wake up is part of the WUR configuration.

Unlike the 3GPP solution, the WUR operation mode is a “sub-state” of the regular operation and upon the detection of a WUS transmission from the AP, the station will resume the power-saving mechanism it was configured with before entering the WUR operation mode. That is, IEEE has specified a number of different power saving mechanisms and, for example, if duty-cycled monitoring of the downlink has been configured for the station it will switch to that upon detection of the WUS (i.e., unlike the specified 3GPP mechanism which only covers paging, and the where the WD continues to monitor PDCCH if WUS is detected). In this way, the IEEE WUR functionality is more general, and still allows for the station to, upon detection of WUS “monitor paging” by checking in the beacon from the AP, determine whether there is data, or allows for the station to directly respond with an uplink transmission.

The physical wake-up signal (WUS) in IEEE contains complete frames which must be processed by the station. The drawback with this design is that it requires more handling and processing in the station, i.e., compared to a simple WUR design which triggers one pre-defined activity in case the WUS is detected. The benefit is that it contains more information, and the solution is more general. The IEEE WUS contains information to indicate if the WUS is a WUR synchronization beacon, a WUR discovery beacon, or a regular WUS (intended to wake the station up). The WUS may also contain proprietary frames, which could e.g., be used to directly turn actuators on/off. The transmission uses on/off keying (OOK) modulation, using Manchester coding, but is using multi-carrier OOK, which may be generated by an orthogonal frequency-division multiplexing (OFDM) transmitter (i.e., WUR may be enabled as a software upgrade in APs). The WUS is 4 MHz wide, but a 20 MHz channel is reserved. The WUS starts with a 20 MHz legacy preamble (to allow other stations to perform carrier sensing) followed by 4 MHz Manchester coded OOK. Two data rates are supported: 62.5 kbps and 250 kbps, and link adaptation is up to the AP (each packet is self-contained and includes the data rate.

I.e., in the WUR there are two possible sync words used to signal the data rate).

### Power Vs. Sensitivity Tradeoff

The design challenge in receivers for IoT applications is to minimize the power consumption with an adequate sensitivity level. In WUR design, receiver sensitivity may be an important parameter, as it provides the lowest power level at which the receiver may detect a WUS. Generally, high sensitivity requires more power consuming electronics (e.g., low noise amplifier (LNA)) at the receiver side, thus high power demand. In contrast, low sensitivity for the same communication range will require high radiated power at the transmitter side. Because of this, sensitivity requirements often lead to over-design to ensure reliable communication in adverse conditions. When the WUR is used to trigger a less energy-efficient and more power consuming main receiver, ideally the WUR and the main receiver should have the same range.

As an example, as shown in FIG. 3, the tradeoff between sensitivity/coverage and energy consumption of WUR is based on the existing low-power radio designs. For every 20 dB improvement in sensitivity, there is at least a 10× increase in power consumption.

### Energy Consumption Vs. Latency Tradeoff

Another tradeoff in WUR design and operation is energy consumption versus latency. For example, to achieve a minimum latency, the WUR may need to be always on to continuously monitor for downlink transmissions (e.g., a WUS). The average power consumption may be reduced by relaxing latency and allowing the WUR to go to sleep modes.

### Impact of False Alarm

In case of false alarm, false paging or in general false wake ups, the WUR falsely detects a WUS and triggers the main radio to wake up and monitor an incoming signal. Such false wake ups result in an additional power consumption, thus decreasing the potential gain of the WUR. For example, FIG. 4 shows that the power saving gain of WUR significantly decreases as the false alarm probability and the number of false wake ups increases.

Although employing a WUR may provide significant power saving for the wireless device, its performance is highly susceptible to false alarm events for which the main radio is mistakenly woken up. Since a wireless device (i.e., main radio) consumes a considerable amount of energy for ramping up/down, false alarm events may result in additional wireless device power consumption (or even negative power saving gain). Therefore, in some existing systems, employing a WUR may not have any benefit, and may also drain the wireless device battery.

### SUMMARY

Some embodiments advantageously provide methods, systems, and apparatuses for wake-up signal synchronization.

The present disclosure provides solutions for a WUR to perform and/or obtain WUS synchronization. The present disclosure also includes solutions for WUS synchronization operations, describing different solutions for the synchronization configuration and possible offset values between the WUS synchronization transmission and the WUS transmission.

Interactions between the WUR and the main radio, including WUR coexistence with the discontinuous reception (DRX) configurations for the main radio, are also considered to ensure reliable wireless device operation even in the event of WUR failure.

The present disclosure provides solutions for a WUR to perform and/or obtain WUS synchronization based on different methods such as:
WUS synchronization based on separate WUS synchronization sequence transmission;
WUS synchronization based on part of the WUS transmission;
Time and frequency offsets between WUS synchronization and WUS transmission;
Periodicity of WUS synchronizations; and/or
Time offsets between WUS synchronization and WUR duty cycle.

The present disclosure also present solutions to ensure that wireless device operations may be maintained even in the event of WUR failure, e.g., based on:
A main radio wake-up timer; and/or
Coexistence with main radio DRX operation.

Solutions described herein provide efficient methods for WUS synchronization to ensure that WUS detection may be performed in an efficient and reliable manner.

Solutions described herein also ensure that wireless device operations in general may be maintained in the event of the WUR failure which is likely considering low-power and simple WUR architectures.

According to one aspect, a network node configured to communicate with a wireless device, WD, is provided. The network node is configured to transmit, using a transmitter of the network node, a wakeup signal, WUS, synchronization sequence to enable a wakeup receiver, WUR, of the WD to synchronize with the transmitter. The network node is also configured to transmit, using the transmitter, a WUS sequence to be received by the WUR of the WD.

According to this aspect, in some embodiments, the WUS synchronization sequence and the WUS sequence are transmitted as separate sequences that are not contiguous in time. In some embodiments, the WUS synchronization sequence and the WUS sequence are contiguous in time. In some embodiments, the WUS synchronization sequence is transmitted to a first set of WDs and the WUS sequence includes a first WUS sequence intended for a first subset of the first set of WDs. In some embodiments, the WUS sequence includes a second WUS sequence intended for a second subset of the first set of WDs. In some embodiments, transmitting the WUS synchronization sequence and the WUS sequence includes transmitting an L bit sequence that includes N bits of the WUS synchronization sequence and L-N bits of the WUS sequence. In some embodiments, the network node is configured to configure first time and frequency domain resources for transmission of the WUS synchronization sequence adjacent to or offset from second time and frequency domain resources for transmission of a synchronization signal block, SSB. In some embodiments, the network node is configured to frequency division multiplex, FDM, the WUS synchronization sequence with a synchronization signal block, SSB. In some embodiments, the network node is configured to configure a time domain periodicity and an offset relative to a reference frame. In some embodiments, the network node is configured to configure a time offset of the WUS synchronization sequence relative to a reference WUS transmission occasion. In some embodiments, a period of a WUS synchronization sequence transmission is different from a duty cycle period of a WUS sequence transmission. In some embodiments, a period of the WUS synchronization sequence is based at least in part on a duty cycle period of a WUS sequence transmission. In some embodiments, resources for WUS synchronization sequence transmission are sparsely distributed relative to resources for WUS sequence transmission.

According to another aspect, a method in a network node configured to communicate with a wireless device, WD, is provided. The method includes transmitting, using a transmitter of the network node, a wakeup signal, WUS, synchronization sequence to enable a wakeup receiver, WUR, of the WD to synchronize with the transmitter. The method also includes transmitting, using the transmitter, a WUS sequence to be received by the WUR of the WD.

According to this aspect, in some embodiments, the WUS synchronization sequence and the WUS sequence are transmitted as separate sequences that are not contiguous in time. In some embodiments, the WUS synchronization sequence and the WUS sequence are contiguous in time. In some embodiments, the WUS synchronization sequence is transmitted to a first set of WDs and the WUS sequence includes a first WUS sequence intended for a first subset of the first set of WDs. In some embodiments, the WUS sequence includes a second WUS sequence intended for a second subset of the first set of WDs. In some embodiments, transmitting the WUS synchronization sequence and the WUS sequence includes transmitting an L bit sequence that includes N bits of the WUS synchronization sequence and L-N bits of the WUS sequence. In some embodiments, the method includes configuring first time and frequency domain resources for transmission of the WUS synchronization sequence adjacent to or offset from a second time and frequency domain resources for transmission of a synchronization signal block, SSB. In some embodiments, the method includes frequency division multiplexing, FDM, the WUS synchronization sequence with a synchronization signal block, SSB. In some embodiments, the method includes configuring a time domain periodicity and an offset relative to a reference frame. In some embodiments, the method includes configuring a time offset of the WUS synchronization sequence relative to a reference WUS transmission occasion. In some embodiments, a period of a WUS synchronization sequence transmission is different from a duty cycle period of a WUS sequence transmission. In some embodiments, a period of the WUS synchronization sequence is based at least in part on a duty cycle period of a WUS sequence transmission. In some embodiments, resources for WUS synchronization sequence transmission are sparsely distributed relative to resources for WUS sequence transmission.

According to yet another aspect, a wireless device, WD, configured to communicate with a network node is provided. The WD is configured to receive a wakeup signal, WUS, synchronization sequence from the network node. The WD is configured to synchronize a wakeup receiver, WUR, of the WD according to the WUS synchronization sequence. The WD is configured to receive by the WUR a WUS sequence from the network node.

According to this aspect, in some embodiments, receiving the WUS synchronization sequence and receiving the WUS sequence includes receiving an L bit sequence having N bits of the WUS synchronization sequence and L-N bits of the WUS sequence. In some embodiments, the WD is configured to receive a time offset of the WUS synchronization sequence relative to a WUS transmission occasion. In some embodiments, a WUR synchronization result of synchronizing the WUR is communicated to a main receiver of the WD. In some embodiments, a main receiver synchronization result of synchronizing a main receiver of the WD is communicated to the WUR. In some embodiments, the WUR is configured with a WUS synchronization sequence length and a WUS sequence length. In some embodiments, the WD is further configured by the network node with time and frequency domain resources for receiving the WUS synchronization sequence and for receiving the WUS sequence. In some embodiments, the configuration of the time and frequency domain resources is received by a main receiver of the WD. In some embodiments, the WD is configured to determine whether to switch to another cell based at least in part on a received signal strength of the WUS synchronization sequence. In some embodiments, upon receiving the WUS synchronization sequence, synchronize a WUR duty cycle period of the WUR to a discontinuous reception, DRX, timing using at least one timing offset value.

According to another aspect, a method in a wireless device, WD, configured to communicate with a network node is provided. The method includes receiving a wakeup signal, WUS, synchronization sequence from the network node. The method includes synchronizing a wakeup receiver, WUR, of the WD according to the WUS synchronization sequence. The method includes receiving by the WUR a WUS sequence from the network node.

According to this aspect, in some embodiments, receiving the WUS synchronization sequence and receiving the WUS sequence includes receiving an L bit sequence having N bits of the WUS synchronization sequence and L-N bits of the WUS sequence. In some embodiments, the method includes receiving a time offset of the WUS synchronization sequence relative to a WUS transmission occasion. In some embodiments, a WUR synchronization result of synchronizing the WUR is communicated to a main receiver of the WD. In some embodiments, a main receiver synchronization result of synchronizing a main receiver of the WD is communicated to the WUR. In some embodiments, the WUR is configured with a WUS synchronization sequence length and a WUS sequence length. In some embodiments, the WD is further configured by the network node with time and frequency domain resources for receiving the WUS synchronization sequence and for receiving the WUS sequence. In some embodiments, the configuration of the time and frequency domain resources is received by a main receiver of the WD. In some embodiments, the WD is configured to determine whether to switch to another cell based at least in part on a received signal strength of the WUS synchronization sequence. In some embodiments, upon receiving the WUS synchronization sequence, synchronize a WUR duty cycle period of the WUR to a discontinuous reception, DRX, timing using at least one timing offset value.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of a WUS and associated paging occasion;

FIG. 2 is a schematic diagram of a WUS for NB-IOT and LTE-M;

FIG. 3 graphical representation of power vs. sensitivity for low power radios;

FIG. 4 is a schematic diagram of the impact of WUR false alarm probability on power saving gain;

FIG. 5 is a schematic diagram of an example network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating example methods implemented in a communication system including a host computer, a network node and a wireless device for executing a client application at a wireless device according to some embodiments of the present disclosure;

FIG. 8 is a flowchart illustrating example methods implemented in a communication system including a host computer, a network node and a wireless device for receiving user data at a wireless device according to some embodiments of the present disclosure;

FIG. 9 is a flowchart illustrating example methods implemented in a communication system including a host computer, a network node and a wireless device for receiving user data from the wireless device at a host computer according to some embodiments of the present disclosure;

FIG. 10 is a flowchart illustrating example methods implemented in a communication system including a host computer, a network node and a wireless device for receiving user data at a host computer according to some embodiments of the present disclosure;

FIG. 11 is a flowchart of an example process in a network node according to some embodiments of the present disclosure;

FIG. 12 is a flowchart of an example process in a wireless device according to some embodiments of the present disclosure;

FIG. 13 is a flowchart of another example process in a network node according to some embodiments of the present disclosure;

FIG. 14 is a flowchart of another example process in a wireless device according to some embodiments of the present disclosure;

FIG. 15 is a schematic diagram of an example wake-up radio according to some embodiments of the present disclosure;

FIG. 16 is a schematic diagram of an example of WUS synchronization according to some embodiments of the present disclosure;

FIG. 17 is a schematic diagram of an example WUS synchronization signal according to some embodiments of the present disclosure;

FIG. 18 is a schematic diagram of an example WUS synchronization according to some embodiments of the present disclosure;

FIG. 19 is a schematic diagram of an example WUS synchronization period and WUR duty cycle period according to some embodiments of the present disclosure;

FIG. 20 is a schematic diagram of an example of a time offset according to some embodiments of the present disclosure;

FIG. 21 is a schematic diagram of an example of a time offset according to some embodiments of the present disclosure; and

FIG. 22 is a schematic diagram of an example WUS-triggered wake-up duration according to some embodiments of the present disclosure.

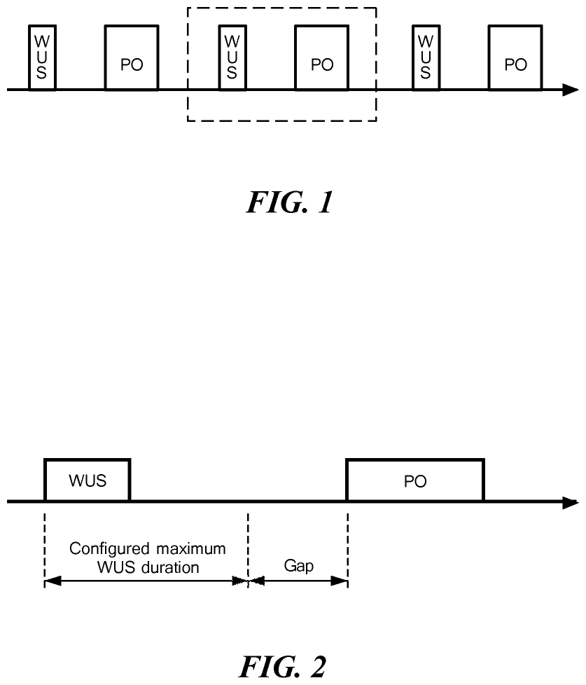

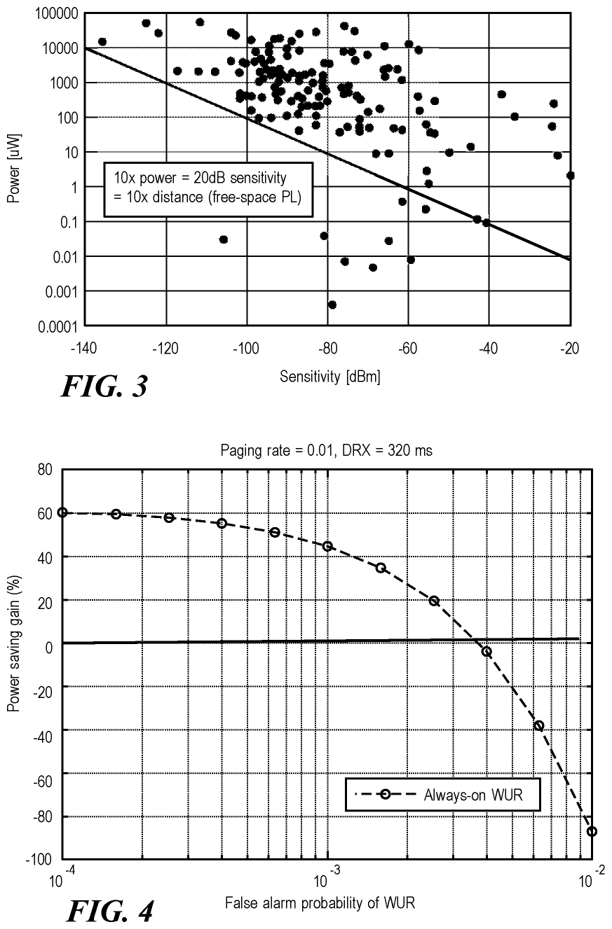

### DETAILED DESCRIPTION

Before describing in detail example embodiments, it is noted that the embodiments reside primarily in combinations of apparatus components and processing steps related to wake-up signal synchronization. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system.

Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for wake-up signal synchronization.

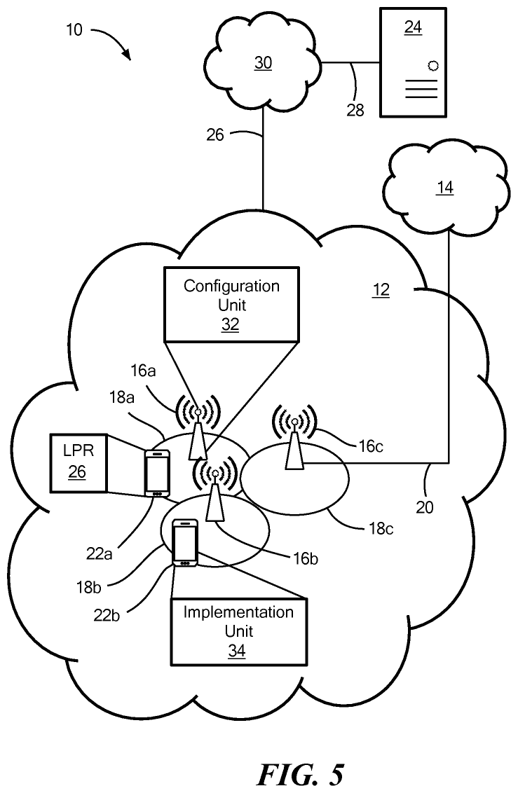

Returning now to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G) and IEEE wireless communication standards, which comprises an access network 12, such as a radio access network, and a core network 14. The access network 12 comprises a plurality of network nodes 16a, 16b, 16c (referred to collectively as network nodes 16), such as NBs, eNBs, gNBs, access points, or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a (user equipment or non-AP station) located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN, and/or an IEEE standard compliant access point.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions described herein, including functions related to wake-up signal synchronization. A wireless device 22 is configured to include an implementation unit 34, which is configured to perform one or more wireless device 22 functions described herein, including functions related to wake-up signal synchronization.

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a control unit 54 configured to enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers (the transmitter portion of the transceiver may be referred to herein as a transmitter and the receiver portion of the transceiver may be referred to herein as a receiver). The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform one or more network node 16 functions described herein, including functions related to wake-up signal synchronization.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers (the transmitter portion of the transceiver may be referred to herein as a transmitter and the receiver portion of the transceiver may be referred to herein as a receiver). For example, radio interface 82 may include a main receiver 83 and a WUR (dedicated receiver) 85.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an implementation unit 34 configured to perform one or more wireless device 22 functions described herein, including functions related to wake-up signal synchronization.

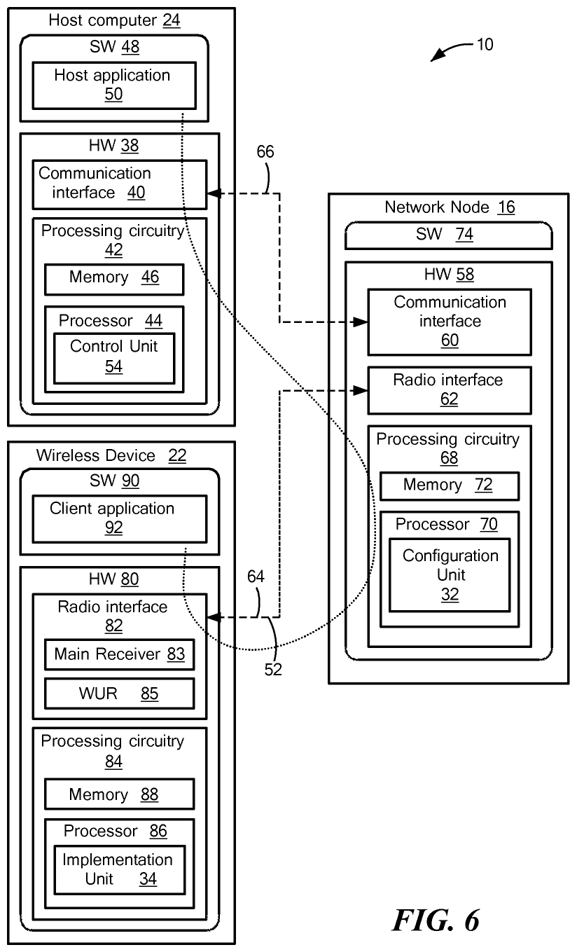

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc. ; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as configuration unit 32, and implementation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

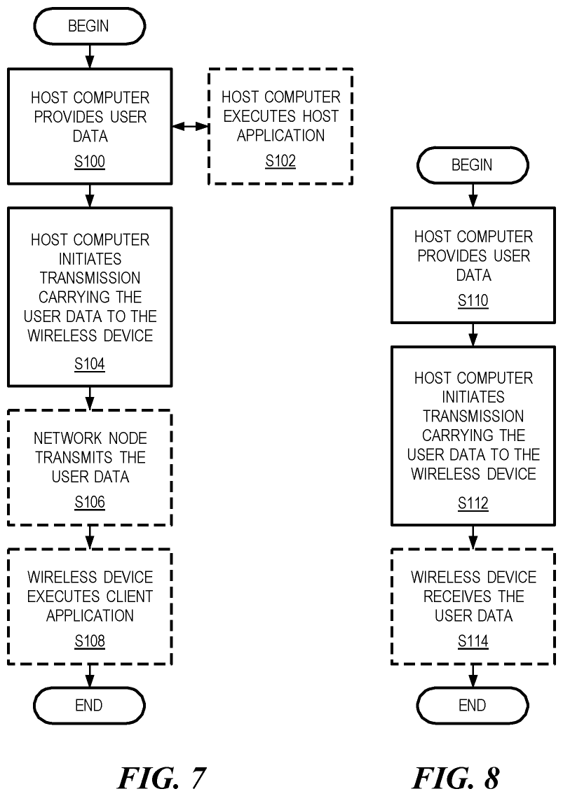

FIG. 7 is a flowchart illustrating an example method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

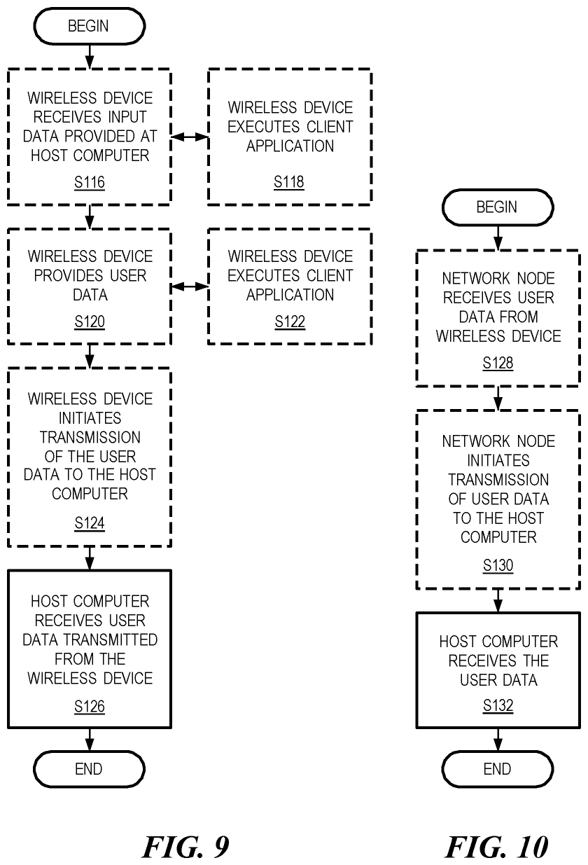

FIG. 9 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

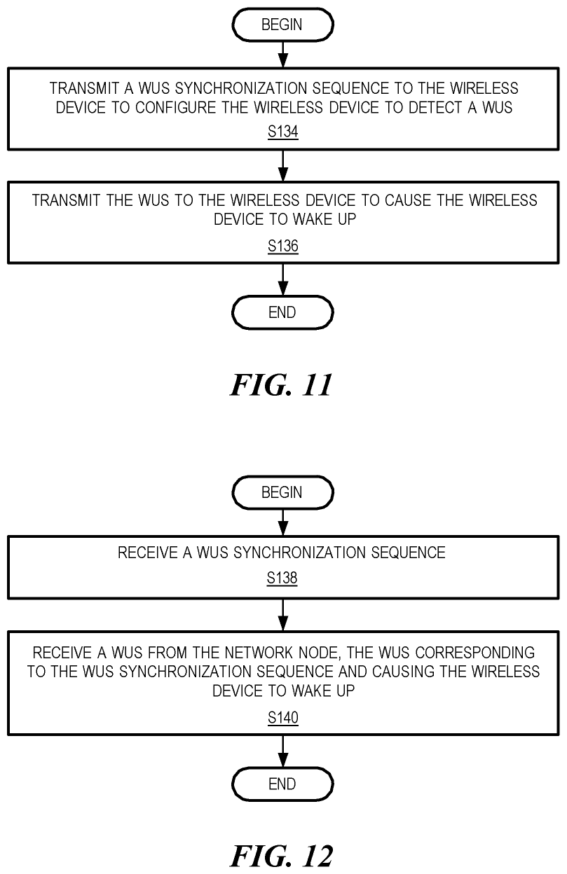

FIG. 11 is a flowchart of an example process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to transmit a wake-up signal, WUS, synchronization sequence to the wireless device 22 to configure the wireless device 22 to detect a WUS (Block S134). Network node 16 is configured to transmit the WUS to the wireless device 22 to cause the wireless device 22 to wake up (Block S136).

In some embodiments the transmitted WUS includes the transmitted WUS synchronization sequence. In some embodiments the WUS synchronization sequence is transmitted using a WUS synchronization signal separate from the transmitted WUS.

FIG. 12 is a flowchart of an example process in a wireless device 22 according to some embodiments of the present. One or more blocks described herein may be performed by one or more elements of wireless device 22 such as by one or more of processing circuitry 84 (including the implementation unit 34), processor 86, radio interface 82 and/or communication interface 60. Wireless device 22 is configured to receive a wake-up signal, WUS, synchronization sequence, (Block S138). Wireless device 22 is configured to receive a WUS from the network node, the WUS corresponding to the WUS synchronization sequence and causing the wireless device 22 to wake up (Block S140).

In some embodiments the received WUS includes the received WUS synchronization sequence. In some embodiments the received WUS synchronization sequence is included in a WUS synchronization signal received separately from the received WUS.

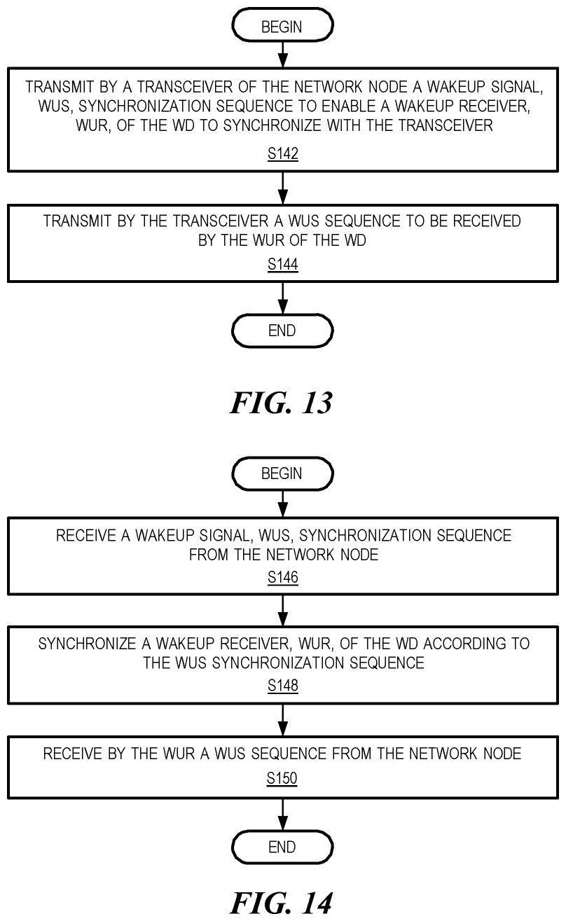

FIG. 13 is a flowchart of an example process in a network node 16 according to some embodiments of the present disclosure. One or more blocks described herein may be performed by one or more elements of network node 16 such as by one or more of processing circuitry 68 (including the configuration unit 32), processor 70, radio interface 62 and/or communication interface 60. Network node 16 is configured to transmit, using a transmitter of the network node 16, a wakeup signal, WUS, synchronization sequence to enable a wakeup receiver, WUR 85, of the WD 22 to synchronize with the transmitter (Block S142). The method also includes transmitting, using the transmitter, a WUS sequence to be received by the WUR 85 of the WD 22 (Block S144).

According to this aspect, in some embodiments, the WUS synchronization sequence and the WUS sequence are transmitted as separate sequences that are not contiguous in time. In some embodiments, the WUS synchronization sequence and the WUS sequence are contiguous in time. In some embodiments, the WUS synchronization sequence is transmitted to a first set of WDs 22 and the WUS sequence includes a first WUS sequence intended for a first subset of the first set of WDs 22. In some embodiments, the WUS sequence includes a second WUS sequence intended for a second subset of the first set of WDs 22. In some embodiments, transmitting the WUS synchronization sequence and the WUS sequence includes transmitting an L bit sequence that includes N bits of the WUS synchronization sequence and L-N bits of the WUS sequence. In some embodiments, the method includes configuring first time and frequency domain resources for transmission of the WUS synchronization sequence adjacent to or offset from a second time and frequency domain resources for transmission of a synchronization signal block, SSB. In some embodiments, the method includes frequency division multiplexing, FDM, the WUS synchronization sequence with a synchronization signal block, SSB. In some embodiments, the method includes configuring a time domain periodicity and an offset relative to a reference frame. In some embodiments, the method includes configuring a time offset of the WUS synchronization sequence relative to a reference WUS transmission occasion. In some embodiments, a period of a WUS synchronization sequence transmission is different from a duty cycle period of a WUS sequence transmission. In some embodiments, a period of the WUS synchronization sequence is based at least in part on a duty cycle period of a WUS sequence transmission. In some embodiments, resources for WUS synchronization sequence transmission are sparsely distributed relative to resources for WUS sequence transmission.

FIG. 14 is a flowchart of an example process in a wireless device 22 according to some embodiments of the present. One or more blocks described herein may be performed by one or more elements of wireless device 22 such as by one or more of processing circuitry 84 (including the implementation unit 34), processor 86, radio interface 82 and/or communication interface 60. Wireless device 22 is configured to receive a wakeup signal, WUS, synchronization sequence from the network node 16 (Block S146). The method includes synchronizing a wakeup receiver, WUR 85, of the WD 22 according to the WUS synchronization sequence (Block S148). The method includes receiving by the WUR 85 a WUS sequence from the network node 16 (Block S150).

According to this aspect, in some embodiments, receiving the WUS synchronization sequence and receiving the WUS sequence includes receiving an L bit sequence having N bits of the WUS synchronization sequence and L-N bits of the WUS sequence. In some embodiments, the method includes receiving a time offset of the WUS synchronization sequence relative to a WUS transmission occasion. In some embodiments, a WUR synchronization result of synchronizing the WUR 85 is communicated to a main receiver of the WD 22. In some embodiments, a main receiver synchronization result of synchronizing a main receiver of the WD 22 is communicated to the WUR 85. In some embodiments, the WUR 85 is configured with a WUS synchronization sequence length and a WUS sequence length. In some embodiments, the WD 22 is further configured by the network node 16 with time and frequency domain resources for receiving the WUS synchronization sequence and for receiving the WUS sequence. In some embodiments, the configuration of the time and frequency domain resources is received by a main receiver of the WD 22. In some embodiments, the WD 22 is configured to determine whether to switch to another cell based at least in part on a received signal strength of the WUS synchronization sequence. In some embodiments, upon receiving the WUS synchronization sequence, synchronize a WUR duty cycle period of the WUR 85 to a discontinuous reception, DRX, timing using at least one timing offset value.

Having described the general process flow of arrangements of the disclosure and having provided examples of hardware and software arrangements for implementing the processes and functions of the disclosure, the sections below provide details and examples of arrangements for wake-up signal synchronization. One or more wireless device 22 functions described below may be performed by one or more of processing circuitry 84, processor 86, implementation unit 34, etc. One or more network node 16 functions described below may be performed by one or more of processing circuitry 68, processor 70, configuration unit 32, etc.

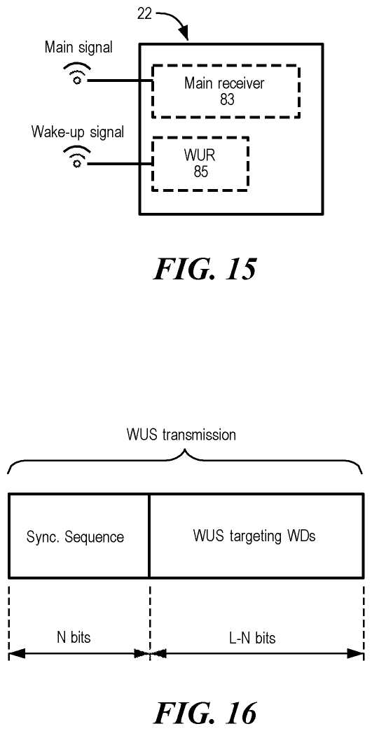

Some embodiments provide for a dedicated wake up radio (WUR) 85 used for monitoring a wake-up signal (WUS). Once the WUR 85 detects the intended WUS, it wakes up the main (baseband/RF/less power efficient) receiver, which may be a component of the wireless device 22, to detect further incoming messages (shown in FIG. 15), such as from the network node 16. Therefore, the main receiver 83 may go to sleep mode and save power until it is triggered by WUR 85.

Given the sensitivity and power consumption tradeoff in designing the WUS and/or the WUR 85, the coverage of the WUR 85 may not be the same as that of the main radio/receiver. In particular, high sensitivity receivers may be needed to reach users located at the cell edge of macro cells or in poor coverage conditions.

### WUS Synchronization

To monitor the WUS properly and efficiently, the WUR 85 may require some degree of synchronization to the network, such as via a network node 16, with regard to the WUS transmission. Various methods to perform WUS synchronization based on different designs of synchronization sequence for WUR 85 are described herein.

### WUS Synchronization Resources

In some embodiments, the WUS synchronization is performed based on a separate synchronization sequence transmitted from the network (such as via the network node 16), i.e., the synchronization sequence is transmitted separately from the WUS. In some examples, the WUS synchronization sequence may be transmitted using a WUS synchronization signal.

The synchronization sequence may be transmitted using the same or different modulation schemes, coding schemes, time and/or frequency resources, and/or transmit power when compared to the WUS transmission. For example, the separate synchronization sequence for WUR 85 may be based on the existing NR synchronization signals such as primary synchronization signal (PSS) or secondary synchronization signal (SSS) using 127 subcarriers in one OFDM symbol, while WUS is transmitted using on-off keying (OOK) modulation, spanning M physical resource blocks (PRBs) in frequency and Q OFDM symbols in time.

In some embodiments, the WUS synchronization is performed based on part of the single WUS sequence transmission. For example, for a length-L WUS sequence, the first N bits of WUS sequence is used for WUS synchronization, and the remaining (L-N) bits are for WUS intended for waking up wireless devices 22.

The synchronization part of the WUS may be the same or different for a WUS targeting different wireless devices 22. In at least one example embodiment, when a WUS is supposed to wake up only wireless devices 22, the synchronization part of the WUS is the same for each wireless device 22, while the remaining part may address specific wireless devices 22 or groups of wireless devices 22, e.g., through some identifier. FIG. 16 shows an example of WUS synchronization performed based on part of a single WUS transmission containing WUS targeting wireless devices 22.

In some embodiments, the WUS synchronization is performed jointly with WUS payload detection based on a WUS sequence transmission. For example, S different sequences are used for joint synchronization and WUS information targeting S wireless devices 22 or groups of wireless devices 22. In this case, each wireless device 22 searches over different pre-defined sequences (e.g., via time correlation) and once it detects the correct one (e.g., maximum correlation which is larger than a threshold), it may synchronize and have remaining bits of WUS information.

Different amounts of resources for WUS synchronization sequence transmissions and WUS sequence transmissions may be needed for different coverage scenarios. In some embodiments described herein, the time and frequency domain resources for WUS synchronization sequence transmissions and WUS sequence transmissions may be configured by the network, such as via the network node 16.

In some embodiments, the synchronization sequence length and WUS sequence length may be configured. The configuration may be performed through higher-layer parameters, where the network, such as via the network node 22, indicates one out of K possible fixed values to the wireless device 22. The possible values may depend on subcarrier spacing (SCS).

In some embodiments, higher layer signaling may configure a set of WUS synchronization resources for transmitting WUS synchronization signal. The resources may include a set of time-domain resources, frequency-domain resources, and a time domain periodicity and offset relative to a reference (e.g., frame number such as SFNO). Since WUS synchronization signals are transmitted periodically, the time domain periodicity and offset may be configurable values and suitable settings may be used to place the WUS synchronization signal close to a synchronization signal block (SSB) transmission (e.g., same/adjacent slots/symbols) to save network energy. In certain embodiments, the network, such as via network node 16, may configure the WUS synchronization signal to be frequency division multiplexing (FDM) with SSB. A wireless device 22 may utilize the main receiver 83 to identify the resources used for WUS synchronization.

Higher layer signaling may configure the set of WUS resources for transmitting WUS, including a set of time-domain resources, frequency-domain resources, and a time domain periodicity and offset relative to a reference (e.g., frame number such as SFNO). Since WUSs targeting wireless devices 22 are transmitted proximate to the paging occasions (depending on the main receiver wakeup time), the time domain periodicity and offset of WUS resources may be configurable values and suitable settings may be used to place the WUS close to an SSB transmission (e.g., same/adjacent slots/symbols) to save network energy. A wireless device 22 may utilize the main receiver 83 to identify the resources used for WUS.

Wireless device 22 may use the main receiver 83 to obtain the higher layer signaling configuring the set of WUS synchronization resources and set of WUS resources. Since the main receiver 83 is also aware of the reference (e.g., frame number such as SFNO), the wireless device 22 may identify the time/frequency domain resources used for WUS synchronization sequence and the relative time/frequency domain resources used for WUS. In other words, in some cases, the relative offset between a WUS synchronization resource and a WUS resource that wireless device 22 expects to monitor is derived by the wireless device 22.

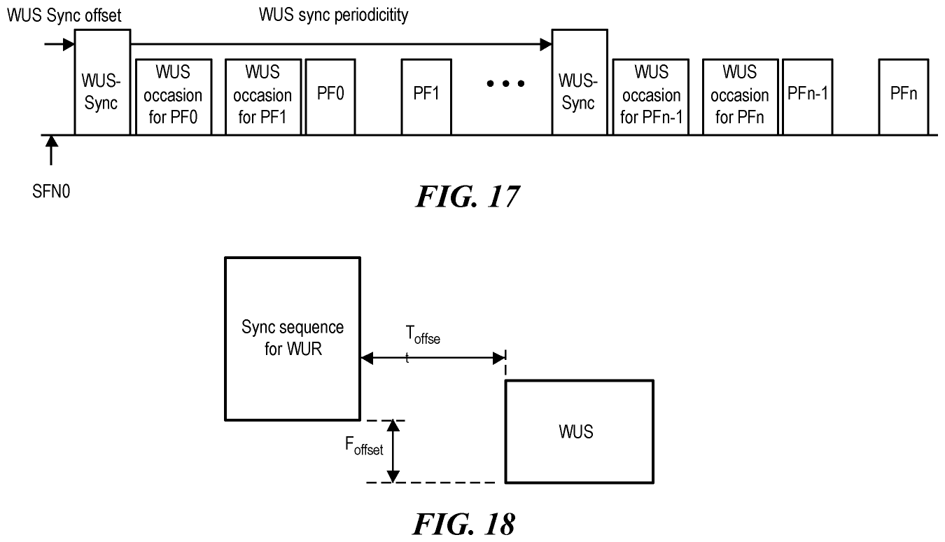

The time domain periodicity of WUS synchronization resources may be the same as or different from those of the WUS resources. For example, since the WUS synchronization resources are persistent, they may be configured more sparsely relative to the WUS resources. For example, for a case with 64 paging frames configured per paging cycle, the network may configure, such as via the network node 16, up to one WUS time/frequency domain resource occasion per paging frame (i.e., 64 WUS time/frequency domain resource occasions), while the network may configure one or two time/frequency domain resource occasions for WUS synchronization resources per paging cycle. This enables multiple wireless devices 22 (e.g., even belonging to different paging frames) to utilize a single WUS synchronization resource to obtain synchronization information. An example is shown in FIG. 17.

The WUS synchronization signal may comprise a set of OFDM symbols on which ON/OFF keying is performed using the WUS synchronization sequence. The WUS synchronization sequence(s) used in a cell may be indicated via higher layer signaling, such as by system information block, MIB, signaling, etc. For example, the exact sequence may be a bitmap with Is and Os, or indicate an initialization seed to generate the sequence. Alternatively, the WUS synchronization sequence may be based on a smaller sequence that is repeated multiple times. The WUS synchronization sequence may have a smaller length than the sequence used for cell identification (such as SSS)-this reduces the resource overhead for WUS synchronization signal transmission.

The WUS synchronization sequence(s) used in a cell may be indicated via higher layer signaling such as system information block, MIB, etc. The WUS synchronization sequence(s) used in one or more neighbor cells may also be indicated via higher layer signaling such as system information block, MIB, etc. along an associated neighbor cell ID. This allows a WUR 85 wireless device 22 to detect and measure serving/neighbor cells based on the WUS synchronization signals. The wireless device 22 may utilize the WUS synchronization signal quality, e.g., received signal strength to switch to another cell, e.g., as part of idle mode cell selection/reselection procedure or to measure the serving cell/neighbor cell quality.

WUS synchronization operations

When the WUR 85 of the WD 22 operates in scenarios where there exists separate WUS synchronization sequence transmissions, the WUR 85 is also expected to monitor and detect such WUS synchronization sequence to obtain some degree of time and/or frequency synchronization for the subsequent WUS detection.

In some embodiments, time and/or frequency offsets between the resource of the WUS synchronization sequence transmission and that of subsequent WUS transmission (or a WUS transmission occasion) are defined (see e.g., FIG. 18). In some cases, the time offset/time location of the WUS synchronization sequence may be defined relative to a reference WUS transmission occasion (e.g., associated with a first paging frame of a paging cycle). The offsets may be fixed in the specification or configured by the network. Alternatively, the offsets may be indicated via some part of the synchronization sequence. Once the WUR 85 detects a WUS synchronization sequence transmission, it may then apply the offsets to obtain some degree of synchronization for the WUS detection. The frequency offset may be indicated in terms of kHz, number of subcarriers, or number of resource blocks. The time offset may be indicated in terms of milli-seconds (ms), number of symbols, or number of slots.

In general, the WUS synchronization sequence may be transmitted periodically. The period of WUS synchronization may be configured by the network, such as via the network node 16.

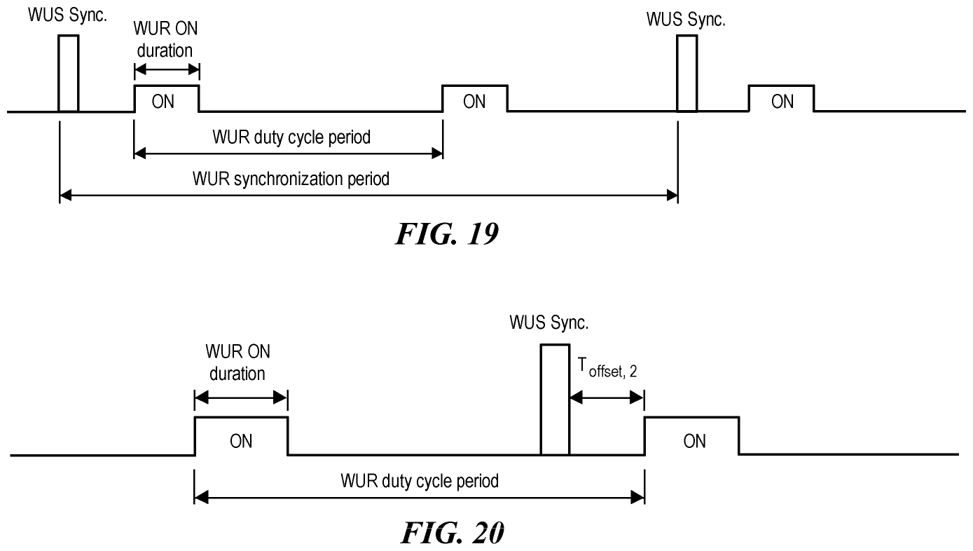

For duty-cycled WUR 85, where wireless device 22 WUR 85 periodically performs WUS detection with an ON and OFF pattern, the period of WUS synchronization sequence transmission may be different from the WUS duty-cycle period (See, e.g., FIG. 19). For example, the period for WUS synchronization may be longer than the WUS duty-cycle if the WUR 85 operates in good coverage scenarios.

In some embodiments, the period of the WUS synchronization sequence transmission and WUS duty cycle may be separately configured by the network. In another embodiment, the period of WUS synchronization sequence transmission is a function of WUS duty cycle. For example, WUS synchronization may be transmitted every T WUS duty cycle.

For a duty cycled WUR 85, the WUS synchronization sequence transmission may occur within or outside the WUR ON duration. In either case, the timing offset between the synchronization sequence transmission and the duty-cycle boundary (e.g., starting point of the WUR ON duration) may be defined so that the WUR 85 may also be synchronized with the WUR duty cycle once the WUS synchronization sequence is detected (as shown, e.g., in FIG. 20 and FIG. 21).

Since the WUR 85 may be operated in different RRC-states. The WUS synchronization may be performed differently in different states.

In some embodiments, the wireless device 22 is expected to perform WUS synchronization only in RRC-Idle or RRC-Inactive states. That is, in RRC-connected state, no specific WUS synchronization is performed by the wireless device 22, i.e., the synchronization for WUR 85 may be based on existing synchronization mechanisms such as those using SSB.

In some embodiments, the wireless device 22 is expected to perform WUS synchronization on a separate synchronization sequence only in RRC-Idle or RRC-Inactive states. In RRC-connected state, no separate WUS synchronization is transmitted from the network and the WUS synchronization may be based on the WUS detection itself or other existing synchronization mechanisms such as those using SSB.

### Interaction Between WUR and Main Radio/Receiver Regarding Synchronization

In general, there are interactions between the WUR 85 and main radio including the main receiver 83. For synchronization, the synchronization result obtained from the main radio may be passed through to the WUR 85 to aid the WUS detection. Conversely, a WUS synchronization result obtained from the WUR 85 may also be passed through to the main receiver 83 to compliment any synchronization performed by the main receiver 83.

In some embodiments, it is preferable that the wireless device 22 operations based on the WUR 85 should be sufficiently reliable. That is, in case of WUR 85 failure, the main receiver 83 is able to wake up by its own to perform some necessary operations such as synchronization and radio measurements.

In some embodiments, for a wireless 22 operated with the WUR 85, the main receiver 83 is configured to wake up on its own after a certain period of sleep regardless of whether WUS is detected by WUR 85. In some example embodiments, the main receiver 83 wakes up every T ms either by itself or as by the WUR 85. To reduce power consumption, a relatively large value of T may be configured, e.g., much longer than the WUR duty cycle.

In some embodiments, the main receiver 83 automatically wakes up depending on the WUR operation. For example, if the main receiver 83 is not triggered by the WUR 85 for a certain time, then it automatically wakes up. In this case, the main receiver 83 does not need to wake up periodically (similar to DRX operation). Instead, it wakes up after an inactivity timer is expired to ensure that the main receiver 83 does not go to the sleep mode for a very long time which results in losing synchronization.

In some embodiments, a synchronization timer is defined for the main receiver 83 to ensure that it wakes up at least once every T ms. Such synchronization timer starts the moment that the main receiver 83 goes to sleep and it resets each time the main receiver 83 wakes up.

In some embodiments, the wireless device 22 only considers that it has been woken up if it detects a paging or PDCCH transmission to the wireless device 22. For example, the wireless device 22 may only reset a synchronization timer if it detects paging or PDCCH after waking up the main receiver 83. This is beneficial since at least because it reduces the probability of the network node 22 and the wireless device 22 having different understanding on when the wireless device 22 will wake up next.

### Relation to Existing DRX Configuration

In some embodiments, the WUR 85 may be operated in connection with the existing DRX configuration for the main receiver 83. In such cases, the main receiver 83 will wake up following the DRX ON duration and may additionally wake up outside of the DRX ON duration if the WUS is detected.

With proper configuration of the DRX period and DRX ON duration, the existing DRX configuration may serve as a fallback option in case of failure of WUR 85.

There may be separate WUS synchronization signal transmission in addition to SSB transmissions. Once the WUS synchronization signal is detected, the wireless device 22 may be synchronized to the DRX ON period/DRX cycle as well as the WUR duty cycle period through some timing offset values.

When the WUS is detected outside of the DRX ON duration, the wireless device 22 main receiver 83 may wake up for a certain time duration, e.g., based on a configured timer. If the WUS-triggered wake-up duration overlaps with the DRX ON duration, the wireless device 22 may continue to stay ON following the DRX ON duration.

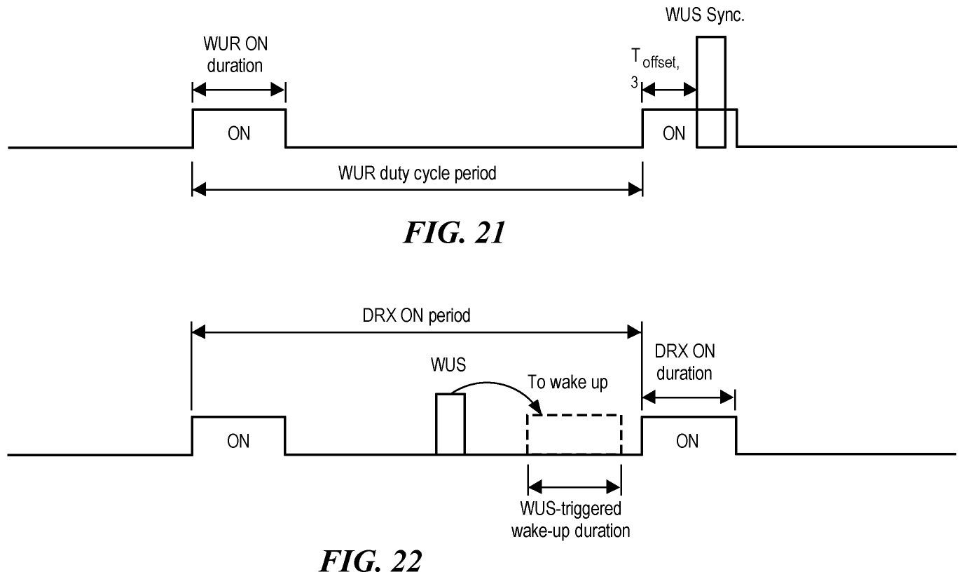

If the WUS-triggered wake-up duration does not overlap with the DRX ON duration, depending on the gap between the two durations, the WUS-triggered wake-up duration may be extended to last until the start of the earliest next DRX ON duration. For example, if the gap is smaller than a certain threshold (e.g., a few OFDM symbols, slots, or ms), it may not be desirable that the main receiver 83 switches back and forth between ON and OFF states within a very short time. In such case, the WUS-triggered wake-up duration may be extended to last until the start of the next DRX ON duration. This is shown in FIG. 22, which illustrates the WUS-triggered wake-up duration that does not overlap with DRX ON duration. If the gap between the WUS-triggered wake-up duration and next earliest DRX ON duration is less than N symbols or ms, the WUS-triggered wake-up duration is extended to last until the start of the next DRX ON duration.

Some embodiments may include one or more of the following:

Embodiment A1. A network node configured to communicate with a wireless device (WD), the network node configured to, and/or comprising a radio interface and/or comprising processing circuitry configured to:
transmit a wake-up signal, WUS, synchronization sequence to the wireless device to configure the wireless device to detect a WUS; and
transmit the WUS to the wireless device to cause the wireless device to wake up.

Embodiment A2. The network node of Embodiment A1, wherein the transmitted WUS includes the transmitted WUS synchronization sequence.

Embodiment A3. The network node of Embodiment A1, wherein the WUS synchronization sequence is transmitted using a WUS synchronization signal separate from the transmitted WUS.

Embodiment B1. A method implemented in a network node, the method comprising:
transmitting a wake-up signal, WUS, synchronization sequence to the wireless device to configure the wireless device to detect a WUS; and transmitting the WUS to the wireless device to cause the wireless device to wake up.

Embodiment B2. The method of Embodiment B1, wherein the transmitted WUS includes the transmitted WUS synchronization sequence.

Embodiment B3. The method of Embodiment B1, wherein the WUS synchronization sequence is transmitted using a WUS synchronization signal separate from the transmitted WUS.

Embodiment C1. A wireless device (WD) configured to communicate with a network node, the WD configured to, and/or comprising a radio interface and/or processing circuitry configured to: receive a wake-up signal, WUS, synchronization sequence; and receive a WUS from the network node, the WUS corresponding to the WUS synchronization sequence and causing the wireless device to wake up.

Embodiment C2. The WD of Embodiment C1, wherein the received WUS includes the received WUS synchronization sequence.

Embodiment C3. The WD of Embodiment C1, wherein the received WUS synchronization sequence is included in a WUS synchronization signal received separately from the received WUS.

Embodiment D1. A method implemented in a wireless device (WD), the method comprising:
receiving a wake-up signal, WUS, synchronization sequence; and receiving a WUS from the network node, the WUS corresponding to the WUS synchronization sequence and causing the wireless device to wake up.

Embodiment D2. The method of Embodiment D1, wherein the received WUS includes the received WUS synchronization sequence.

Embodiment D3. The method of Embodiment D1, wherein the received WUS synchronization sequence is included in a WUS synchronization signal received separately from the received WUS.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
ADC Analog to Digital Convertor
DRX Discontinuous Reception
FDM Frequency Division Multiplexing
LNA Low-noise Amplifier
MIB Master Information Block
ms millisecond
NW Network
OOK On-Off Keying
PBCH Physical Broadcast Channel
PSS Primary Synchronization Signal
PLL Phase Locked Loop
RSRP Reference Signal Received Power
RSRQ Reference Signal Received Quality
SCS Subcarrier spacing
SFN Subframe Number
SSB Synchronization Signal Block
SSS Secondary Synchronization Signal
SINR Signal to noise plus interference
WUR Wake-Up Radio
WUS Wake-Up Signal
It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-46. (canceled)

47. A method in a network node configured to communicate with a wireless device, WD, the method comprising:
transmitting, using a radio interface of the network node, a wakeup signal, WUS, synchronization sequence to enable a wakeup receiver, WUR, of the WD to synchronize with the radio interface; and
transmitting, using the radio interface, a WUS sequence to be received by the WUR of the WD.

48. The method of claim 47, wherein:
the WUS synchronization sequence and the WUS sequence are transmitted as separate sequences that are not contiguous in time; or
the WUS synchronization sequence and the WUS sequence are contiguous in time.

49. The method of claims 47, wherein the WUS synchronization sequence is transmitted to a first set of WDs and the WUS sequence includes:
a first WUS sequence intended for a first subset of the first set of WDs; or
a second WUS sequence intended for a second subset of the first set of WDs.

50. The method of claim 47, wherein transmitting the WUS synchronization sequence and the WUS sequence includes transmitting an L bit sequence that includes N bits of the WUS synchronization sequence and L-N bits of the WUS sequence.

51. The method of claim 47, further comprising:
configuring first time and frequency domain resources for transmission of the WUS synchronization sequence adjacent to or offset from second time and frequency domain resources for transmission of a synchronization signal block, SSB; or
frequency division multiplexing, FDM, the WUS synchronization sequence with a synchronization signal block, SSB.

52. The method of claim 47, further comprising configuring a time offset of the WUS synchronization sequence relative to a reference WUS transmission occasion.

53. The method of claim 47, wherein:
a period of a WUS synchronization sequence transmission is different from a duty cycle period of a WUS sequence transmission; or
a period of the WUS synchronization sequence is based at least in part on a duty cycle period of a WUS sequence transmission.

54. The method of claim 47, wherein resources for WUS synchronization sequence transmission are sparsely distributed relative to resources for WUS sequence transmission.

55. A network node configured to communicate with a wireless device, WD, the network node configured to:
transmit, using a radio interface of the network node, a wakeup signal, WUS, synchronization sequence to enable a wakeup receiver, WUR, of the WD to synchronize with the radio interface; and
transmit, using the radio interface, a WUS sequence to be received by the WUR of the WD.

56. The network node according to claim 55, wherein:
the network node is further configured to transmit the WUS synchronization sequence and the WUS sequence as separate sequences that are not contiguous in time; or
the WUS synchronization sequence and the WUS sequence are contiguous in time.

57. A method in a wireless device, WD, configured to communicate with a network node, the method comprising:
receiving a wakeup signal, WUS, synchronization sequence from the network node;
synchronizing a wakeup receiver, WUR, of the WD according to the WUS synchronization sequence; and
receiving by the WUR a WUS sequence from the network node.

58. The method of claim 57, wherein receiving the WUS synchronization sequence and receiving the WUS sequence includes receiving an L bit sequence having N bits of the WUS synchronization sequence and L-N bits of the WUS sequence.

59. The method of claim 57, further comprising receiving a time offset of the WUS synchronization sequence relative to a WUS transmission occasion.

60. The method of claim 57, wherein a WUR synchronization result of synchronizing the WUR is communicated to a main receiver of the WD.

61. The method of claim 57, wherein a main receiver synchronization result of synchronizing a main receiver of the WD is communicated to the WUR.

62. The method of claim 57, wherein the WUR is configured with a WUS synchronization sequence length and a WUS sequence length.

63. The method of claim 57, wherein the WD is further configured by the network node with time and frequency domain resources for receiving the WUS synchronization sequence and for receiving the WUS sequence.

64. The method of claim 63, wherein the configuration of the time and frequency domain resources is received by a main receiver of the WD.

65. The method of claim 57, wherein the WD is configured to determine whether to switch to another cell based at least in part on a received signal strength of the WUS synchronization sequence.

66. The method of claim 57, wherein, upon receiving the WUS synchronization sequence, synchronize a WUR duty cycle period of the WUR to a discontinuous reception, DRX, timing using at least one timing offset value.
